(19) United States
(12) Patent Application Publication
(10) Pub. No.: US 2015/0116361 A1
(43) Pub. Date: Apr. 30, 2015

(54) METHOD FOR DISPLAYING MEDICAL IMAGE DATA

(71) Applicant: Siemens Aktiengesellschaft, Munich (DE)

(72) Inventors: Harald BRAUN, Muenchen (DE); Matthias FENCHEL, Erlangen (DE); Harald H. QUICK, Erlangen (DE)

(21) Appl. No.: 14/519,219

(22) Filed: Oct. 21, 2014

(30) Foreign Application Priority Data
Oct. 29, 2013 (DE) 102013221949.0

(51) Int. Cl. G06T 11/60

(52) U.S. Cl. CPC G06T 11/60; G06T 2200/24; G06T 2200/32
USPC 345/634

(57) ABSTRACT

An embodiment relates to a method for displaying medical image data, a user interface, a medical imaging device and/or a computer program product. In order to enable the meaningful display of medical image data, the method for displaying medical image data includes capture of medical image data; determining of at least one image quality parameter for at least one image of the medical image data, wherein the at least one image quality parameter comprises an image quality of the at least one image based on an item of spatial information and/or an item of temporal information; and display of the at least one image together with a representation of the at least one image quality parameter.

### PRIORITY STATEMENT

The present application hereby claims priority under 35 U.S.C. §119 to German patent application number DE 102013221949.0 filed Oct. 29, 2013, the entire contents of which are hereby incorporated herein by reference.

### FIELD

At least one embodiment of the invention generally relates to method for displaying medical image data, a user interface, a medical imaging device and/or a computer program product.

### BACKGROUND

In medical imaging, medical image data which has a significance relating to an anatomical, physiological and/or biochemical state of a body is generated by way of medical imaging devices. Depending on the measuring conditions and/or measuring parameters used during the capture of the medical image data, the medical image data can have a different image quality. The image quality of the medical image data is here often decisive for the significance of the medical image data.

### SUMMARY

At least one embodiment of the invention is to enable the meaningful display of a quality of medical image data. Advantageous embodiments are described in the subsidiary claims.

At least one embodiment of the invention relates to a method for displaying medical image data with the following method steps:
capture of medical image data,
determining of at least one image quality parameter for at least one image of the medical image data, wherein the at least one image quality parameter comprises an image quality of the at least one image based on an item of spatial information and/or an item of temporal information, and
display of the at least one image together with a representation of the at least one image quality parameter.

The inventive medical imaging device of at least one embodiment has an image data recording unit, an arithmetic unit and a display unit, wherein
the image data recording unit is embodied for the capture of medical image data,
the arithmetic unit is embodied for determining at least one image quality parameter for at least one image of the medical image data, wherein the at least one image quality parameter comprises an image quality of the at least one image based on an item of spatial information and/or an item of temporal information and
the display unit is embodied for displaying the at least one image together with a representation of the at least one image quality parameter.

Embodiments of the inventive medical imaging devices are designed analogously to the embodiments of the inventive method. To this end, computer programs and further software, by which a processor of the medical imaging device automatically controls and/or executes a method sequence of an inventive method, can be stored in a storage unit of the medical imaging device. By way of the combined display of the medical image data together with the representation of the at least one image quality parameter, the inventive medical imaging device thus enables a comprehensible, effective and reliable assessment of the medical image data by an observer.

One embodiment provides that the medical imaging device has a data transmission unit between the image data recording unit and the arithmetic unit, wherein the data transmission unit is embodied for the transfer of measuring parameters, which are used during capture of the medical image data by way of the medical imaging device, from the image data recording unit to the arithmetic unit, to determine the at least one image quality parameter based on the measuring parameters. The data transmission unit can comprise a data cable and/or an interface. The measuring parameters in particular do not mean those measuring parameters which are not already stored in the arithmetic unit, for example as the result an entry by a user. Rather, those measuring parameters are advantageously meant, which are used in an actual capture of the medical image data by the medical imaging device, for example the actual trajectory of the patient couch and/or the actual spatial distribution of the sensitivity of the medical imaging device. The data transmission unit offers a particularly effective possibility for transfer of the measuring parameters from the image data recording unit to the arithmetic unit, so that the arithmetic unit particularly can calculate the at least one image quality parameter in a simple manner based on the measuring parameters.

The inventive computer program product can be loaded directly into a memory of a programmable arithmetic unit of a user interface, and has program code segments, in order to perform an inventive method, when the computer program product is performed in the arithmetic unit of the user interface. Alternatively or additionally the inventive computer program product can also be able to be loaded directly into a memory of a programmable arithmetic unit of a medical imaging device and have program code segments, in order to perform an inventive method, when the computer program product is performed in the arithmetic unit of the medical imaging device. The inventive method can thereby be performed in a rapid, identically repeatable and robust manner. The computer program product is configured in such a way that it can perform the inventive method step by way of the arithmetic unit. The arithmetic unit must here in each case have the prerequisites, such as for example having an appropriate main memory, an appropriate graphics card or an appropriate logic unit, so that the respective method steps can be performed in an efficient manner. The computer program product is for example stored on a computer-readable medium or on a network or server, from where it can be loaded onto the processor of a local arithmetic unit, which is directly connected to the user interface and/or the medical imaging device or can be embodied as part of the user interface and/or of the medical imaging devices. Furthermore, control information of the computer program product can be stored on an electronically readable data carrier. The control information of the electronically readable data carrier can be embodied in such a way that when the data carrier is used in an arithmetic unit of the user interface and/or of the medical imaging device, it performs an inventive method. Examples of electronically readable data carriers are a DVD, a magnetic tape or a USB stick, on which electronically readable control information, in particular software (cf. above), is stored. When the control information (software) is read from the data carrier and stored in a controller and/or arithmetic unit of the user interface and/or of the medical imaging device, all inventive embodiments of the previously described method can be performed.

The advantages of the inventive user interface, of the inventive medical imaging device and of the inventive computer program product essentially correspond to the advantages of the inventive method, which have previously been listed in detail. Features, advantages or alternative embodiments mentioned here are likewise also to be transferred to the other claimed objects, and vice versa. In other words, the material claims can also be developed with the features which are claimed or described in conjunction with a method. The corresponding functional features of the method are here embodied by way of corresponding material modules, in particular by hardware modules.

### BRIEF DESCRIPTION OF THE DRAWINGS

The invention is described and explained in greater detail below, on the basis of the example embodiments shown in the figures.

Wherein:

FIG. 1 shows a combined magnetic resonance PET device for performing of an an embodiment of inventive method in a schematic representation,

FIG. 2 shows a flow chart of an embodiment of an inventive method and

FIG. 3 shows an example display of a coronal slice of PET image data with an associated representation of a PET image quality parameter,

FIG. 4 shows an example display of an axial slice of PET image data with an associated representation of a PET image quality parameter and

FIG. 5 shows an example display of a further axial slice of PET image data with an associated representation of a PET image quality parameter.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

At least one embodiment of the invention is to enable the meaningful display of a quality of medical image data. Advantageous embodiments are described in the subsidiary claims.

At least one embodiment of the invention relates to a method for displaying medical image data with the following method steps:
capture of medical image data,
determining of at least one image quality parameter for at least one image of the medical image data, wherein the at least one image quality parameter comprises an image quality of the at least one image based on an item of spatial information and/or an item of temporal information, and
display of the at least one image together with a representation of the at least one image quality parameter.

The capture of the medical image data can comprise a recording of the medical image data, in particular via a medical imaging device. Alternatively or additionally the capture of the medical image data can comprise a loading of previously recorded medical image data, for example from a database. The medical image data typically comprises a multiplicity of images, which for example comprise different spatial and/or temporal representations of, in particular, anatomical, physiological and/or biochemical properties of an object under investigation, in particular of a human body. The images of the medical image data are typically two-dimensional slice images and jointly form the three-dimensional medical image data record. The multiplicity of images of the medical image data can then for example be arranged axially as slices along a patient's longitudinal axis. The multiplicity of images can also be arranged perpendicularly to the patient's longitudinal axis in sagittal or coronal form. The multiplicity of images of the medical image data can represent a temporal course of the medical image data, in particular during a dynamic measurement, for example of the course of a distribution of a contrast agent. The at least one image quality parameter based on this item of temporal information, in particular based on the temporal course of the medical image data, can then be determined.

The fact that the at least one image quality parameter comprises an image quality of the at least one image based on an item of spatial information and/or an item of temporal information, can mean that the one image quality parameter is determined on the basis of a geometry, for example a spatial orientation and/or position, of the at least one image and/or a chronological sequence and/or position of the at least one image. The at least one image quality parameter can be determined for each image of the medical image data or also only for a subset of the images of the medical image data. Alternatively or additionally an image quality parameter data can be determined collectively for a multiplicity of images of the medical image. The image quality of a multiplicity of images can thus be described collectively by one image quality Parameter. Alternatively or additionally one image quality parameter can also be determined for an image of the medical image data as a whole. The image quality parameter then represents an average of the image quality of the image. Alternatively or additionally the at least one image quality parameter can also be determined spatially resolved for the at least one image. For this purpose the at least one image quality parameter can in each case be determined separately for a partial area of the image, in particular for individual rows, columns, pixels and/or voxels of the image.

The displaying of the at least one image takes place together with the display of a representation of the at least one image quality parameter. Here ‘together’ means in particular, that the at least one image is shown simultaneously with the representation of the at least one image quality parameter. Alternatively or additionally ‘together’ can also mean that the at least one image is shown jointly with the representation of the at least one image quality parameter in one window of a user interface. Alternatively or additionally ‘together’ can also mean that the at least one image is displayed in a spatial relationship to the at least one image quality parameter. The representation of the at least one image quality parameter can thus comprise a profile of a distribution of the image quality parameter, wherein the profile is advantageously arranged spatially adjacent to the display of the at least one image on the display unit and/or is overlaid on the display of the at least one image. Advantageously also conceivable is a representation of the at least one image quality parameter as a spatially resolved image quality map, which has similar dimensions to the at least one image. The image quality map can then be displayed overlaid on and/or merged with the at least one image. The representation of the at least one image quality parameter advantageously takes place depending on the spatial orientation and/or the spatial position and/or the chronological sequence of the at least one image.

The proposed method of at least one embodiment for displaying of the medical image data is based on the consideration that depending on the nature of the capture of the medical image data and/or depending on the imaging modality used it can happen that different images, in particular different slices, of the medical image data have a different image quality. The different image quality can manifest itself for example in a different signal-to-noise ratio of the different images, in particular slices, of the medical image data. A different image quality can also occur within individual images of the medical image data, for example along different lines and/or columns of the individual images. This can for example be the case if multiplanar reformattings on three-dimensional image data have been used. When observing and/or assessing medical image data, persons skilled in the art are accustomed to a homogeneous image quality, for example a homogeneous signal-to-noise ratio, across individual images of the medical image data and/or across the whole of the medical image data. Persons skilled in the art possibly even assume this homogeneity of the image quality when assessing the medical image data. A different image quality within the medical image data can therefore disrupt the visual impression of the medical image data for an observer and lead to errors in the assessment of the medical image data by a person skilled in the art. Thus, for example, reduced image quality in one area of the medical image data can be assessed as an artifact and/or as pathology, insofar as there is no knowledge that the reduced image quality is attributable for example to a special recording technique in the capture of the medical image data.

The proposed combined displaying of the at least one image together with a representation of the at least one image quality parameter allows an observer of the at least one image immediately to recognize how good the image quality of the image or area of the image under observation is. An observer can then immediately recognize in which images of the medical image data and/or in which partial areas of the at least one image a reduced image quality is present. Based on the proposed displaying of the medical image data, an observer of the medical image data can thus particularly simply recognize whether an assessment of the medical image data is disrupted as a result of reduced image quality, for example as a result of increased noise. Based on the representation of the at least one image quality parameter an observer of the medical image data can also come to a decision as to whether additional image data should be captured, in particular for images with a reduced image quality parameter. The proposed combination of the displaying of the at least one image together with the displaying of the representation of the at least one image quality parameter thus increases the significance of the at least one image. It enables a confident assessment of the at least one image by a person skilled in the art, based on the respective representation of the at least one image quality parameter. The proposed combined representation also reduces the danger of mistaken assessments of the at least one image of the medical image data.

One embodiment provides that the at least one image quality parameter describes a relationship between a signal strength and/or a contrast strength of the medical image data and noise in the medical image data. The relationship between the signal strength and the noise is generally known as signal-to-noise ratio. The relationship between the contrast strength and the noise is usually called contrast-to-noise ratio. In medical imaging the signal-to-noise ratio and/or the contrast-to-noise ratio describe important aspects of the image quality of an image. The signal-to-noise ratio and/or contrast-to-noise ratio thus represent typical and meaningful image quality parameters.

One embodiment provides that the representation of the at least one image quality parameter comprises a color coding of the at least one image quality parameter, wherein the color coding depends on at least one value of the at least one image quality parameter. Different values of the at least one image quality parameter can thus be assigned different colors for the representation of the at least one image quality parameter. The colors can be assigned according to a color palette or a grayscale palette. The assignment can take place on a continuous basis or, as described in the following paragraphs, based on threshold values for the at least one value of the image quality parameter. The color coding of the at least one image quality parameter can provide an observer of the at least one image with a particularly simple impression of the image quality of the at least one image. A color coding can thus make evident, in a particularly simple manner, at which points of the at least one image or of the medical image data a high, adequate or low image quality is present. A high image quality is here advantageously indicated with a color with a positive color impact, for example green. A low image quality is advantageously indicated with a color with a negative or cautionary color impact, for example red.

One embodiment provides that the color coding is dependent on at least one threshold value for the at least one value of the at least one image quality parameter. In particular, no continuous assignment of the value of the at least one image quality parameter to a color then takes place, but instead certain colors are used for representation of the at least one image quality parameter depending on at least one threshold value of the image quality parameter. In the simplest case, for example, a threshold value is set for the image quality parameter. If the value of the image quality parameter then lies above the threshold value, a first color is used for representation of the image quality parameter. If the value of the image quality parameter is below the threshold value, then a second color is used for representation of the image quality parameter. The use of any number of threshold values for a more precise differentiation of the representation of the image quality parameter is of course conceivable. The use of threshold values for color coding of the image quality parameter has the result that the observer of the at least one image can record the distribution of the at least one image quality parameter with the at least one image quality parameter particularly simply, and can thus classify the image quality of the at least one image. The at least one threshold value can here in particular be permanently prescribed, automatically adjusted to the medical image data with the aid of an algorithm and/or set and/or adjusted by a user. The at least one threshold value can thus be more narrowly set and/or varied by an adjusted value as required, so that smaller tolerances and fluctuations of the at least one image quality parameter can also be visualized.

One embodiment provides that the representation of the at least one image quality parameter comprises a representation of a change of the at least one image quality parameter along at least one spatial and/or temporal dimension of the at least one image. The representation of the at least one image quality parameter can thus take place along one, two or three spatial directions. In addition, a representation of the at least one image quality parameter along a temporal direction is in each case still possible. The representation of the at least one image quality parameter can, for example, take place by way of a bar, which in particular contains a color coding of the distribution of the at least one image quality parameter. The bar can be oriented along a spatial dimension, in particular a spatial axis, of the at least one image. Alternatively a multiplicity of images of the medical image data can also be represented arranged along a time axis according to their chronological sequence. The at least one image quality parameter can here also be represented along this time axis, in particular in color-coded form. In both cases, this representation of the at least one image quality parameter can particularly effectively describe the distribution and/or change of the at least one image quality parameter with spatial reference to at least one image and/or according to a reference to the chronological sequence of a multiplicity of images.

One embodiment provides that the determining of the at least one image quality parameter takes place depending on a reference value of the at least one image quality parameter. The reference value can be determined on the basis of the at least one image and/or of the medical image data. The reference value can thus for example be a maximum value of the at least one image quality parameter relating to the at least one image and/or the medical image data. Alternatively or additionally the reference value can also be determined based on measuring parameters used during capture of the medical image data. Alternatively or additionally the reference value can also be prescribed by a user. Alternatively or additionally the reference value can represent an ideal value of the image quality parameter. The determining of the at least one image quality parameter depending on the reference value can comprise the determining of a relationship between the at least one image quality parameter and the reference value. The relationship can be expressed as a percentage, wherein a higher percentage value represents a higher image quality. In particular, the aforementioned threshold values can also be determined depending on the relationship between the image quality parameter and the reference value. Threshold values in the range of 90-100 percent, 40-60 percent and 0-10 percent are, for example, advantageous. Any other percentage threshold values, which can also be set, are of course conceivable. Non-linear relationships and/or representations of the at least one image quality parameter to the reference value are also conceivable. For example in the case of more complex noise behavior, in particular with an exponential temporal decay curve, such as for example occurs with PET-imaging, the at least one image quality parameter can behave in a non-linear manner in relation to the reference value. Thus, for example, the signal-to-noise ratio increases with the root of the measuring time. The relationship of the at least one image quality parameter to the reference value can be corrected for this non-linear effect.

One embodiment provides that the at least one image quality parameter is determined by way of the medical image data. The at least one image quality parameter can thus be determined algorithmically, in particular by way of a customary method, from the medical image data and/or from the at least one image.

One embodiment provides that the at least one image quality parameter is determined based on measuring parameters, which are set for capture of the medical image data. This is a particularly advantageous possibility of determining the at least one image quality parameter. The determining of the at least one image quality parameter can take place exclusively based on the measuring parameters. The determining of the at least one image quality parameter can however also take place in combined form based on the measuring parameters and the medical image data. Determining of the at least one image quality parameter based on the measuring parameters is based on the consideration that the measuring parameters provides information as to which spatial and/or temporal distribution of the image quality of the medical image data is to be expected. One example measuring parameter comprises the measuring times for the capture of partial areas of the medical image data. A long measuring time for a partial area of the medical image data then typically leads to a higher image quality of the partial area than a brief measuring time. The measuring parameters thus enable an effective estimation of the spatial and/or temporal distribution of the at least one image quality parameter.

One embodiment provides that a remeasurement for the capture of further medical image data by way of a medical imaging devices is planned on the basis of a spatially resolved distribution of the at least one image quality parameter, wherein the at least one image quality parameter of the further medical image data has a minimum value. In particular, the remeasurement can comprise a capture of further image data, which is in particular captured in those spatial partial areas of the medical image data in which a lower image quality parameter, which is for example lower than a particular minimum value, is present. The remeasurement is thus performed to obtain a higher quality for the further medical image data. The minimum value can here represent a desired minimum measurement for the at least one image quality parameter. The image quality parameter of the further medical image data can have the minimum value across the entire further medical image data. The image quality parameter of the further medical image data can have a minimum value over a partial area, in particular a partial area of the medical image data record relevant to the observer. The remeasurement can serve to homogenize the image quality of the further medical image data relative to the medical image data already captured. The remeasurement can thus improve the image quality of the further medical image data relative to the medical image data already captured, in a selective and efficient manner.

One embodiment provides that an adjustment of remeasurement parameters for the remeasurement takes place depending on the at least one image quality parameter. Additionally, the adjustment of the remeasurement parameters for the remeasurement can also take place depending on the at least one image displayed. The adjustment of the remeasurement parameters can also comprise non-execution of the remeasurement. Advantageously, the adjustment of the remeasurement parameters for the remeasurement takes place via a user. For this purpose the user can be provided with the planning for the remeasurement and/or a suggestion for the remeasurement. This can also take place in that the image quality parameter of the further medical image data to be anticipated from the remeasurement is visualized for comparison with the actual image quality parameter. The adjustment of the remeasurement parameters takes place advantageously depending on the representation of the at least one image quality parameter displayed. In particular, the representation of the at least one image quality parameter displayed facilitates the user's decision as to whether remeasurement should be performed and if so, which measuring parameters are advantageous for the remeasurement.

One embodiment provides that the provision of the medical image data comprises a capture of a raw image data record, wherein the medical image data is generated on the basis of the raw image data record. The recording of the raw image data record typically takes place by way of a medical imaging device. The present method for displaying the medical image data together with a representation of the at least one image quality parameter is then particularly advantageous if the recording of the raw image data record is embodied in such a way that the medical image data generated from the raw image data record has an inhomogeneity of image quality over the image data and/or over at least one image of the medical image data.

One embodiment provides that the recording of the raw image data record takes place at different recording positions. Advantageously, the recording of the raw image data record here takes place by way of a medical imaging device with a patient couch and patient arranged on the patient couch, wherein the capture of the raw image data record takes place in a multiplicity of positions of the patient couch. In particular, through the movement of the patient couch, different recording positions of the patient couch, in particular along the direction of the main magnetic field, the z direction, are here traversed for capture of the medical image data. In particular, image data of the patient is initially captured in a first position of the patient couch. The patient couch is then placed in a further position, after which a renewed capture of medical image data of the patient takes place. This process can be repeated as often as desired. Here, the positions of the patient couch are typically known as bed positions. Different positions of the patient couch are frequently used in magnetic resonance-imaging and/or in combined positron emission tomography magnetic resonance imaging. Depending on the duration of the capture of the raw image data record for one position of the patient couch, the image quality of the medical image data generated from the raw image data record in that position of the patient couch is typically disparate. Thus an extended duration of capture in one position of the patient couch with otherwise identical measuring conditions typically results in a higher image quality of the generated medical image data in that spatial position of the patient couch. If there are different durations for the capture of the raw image data records for different positions of the patient couch, an inhomogeneous distribution of the image quality across the medical image data can occur. It is then particularly advantageous that a combined display of the at least one image of the medical image data and of the at least one image quality parameter takes place. Also, inadequate overlapping of the fields-of-view when capturing the raw image data record at different positions of the patient couch may lead to an inhomogeneous distribution of the image quality of the medical image data. This is in particular then the case, if the fields-of-view of the image data captured in the different couch position do not overlap or have too little overlap. Furthermore, a spatially different sensitivity of the medical imaging devices can cause an additional spatial weighting of the image quality of the medical image data.

One embodiment provides that the recording of the raw image data record takes place by way of a medical imaging device with a patient couch and a patient arranged on the patient couch, wherein the recording of the raw image data record takes place subject to a continuous movement of the patient couch. A continuous movement of the patient couch is in particular advantageous in the case of positron emission tomography, single photon emission tomography, magnetic resonance tomography and computer tomography, in particular also in the case of combined methods using these imaging modalities. The continuous movement of the couch can have the result that a different image quality of the medical image data occurs, in particular along the direction of travel of the patient couch, which is usually arranged along the longitudinal direction of the patient, the axial direction (z direction). In particular, in the case of positron emission tomography, the image quality of a slice depends on the duration of data capture for the slice. As the speed of the continuous movement of the patient couch can vary and/or certain areas of the patient can be traversed more frequently, the image quality of the acquired slices of the medical image data will also vary. It is thus particularly advantageous to represent the medical image data recorded by way of a continuous movement of the couch together with a display of the at least one image quality parameter. This then enables a reliable and comprehensible assessment of medical image data thus captured.

One embodiment provides that the recording of the raw image data record takes place by way of a magnetic resonance device using a magnetic resonance sequence, wherein the magnetic resonance sequence comprises a parallel imaging component. The magnetic resonance device can also be part and/or an imaging modality of a combined medical imaging device, for example of a combined magnetic resonance PET device. A magnetic resonance sequence with a parallel imaging component serves in particular to provide faster data capture. Known methods for parallel imaging in magnetic resonance tomography are for example SMASH, SENSE, GRAPPA, mSENSE or iPAT. The medical image data captured by way of such a magnetic resonance sequence with a parallel imaging component is typically subject to a spatial variance of the noise within an image. The image quality within an image captured in this way often differs within the image. The proposed combined representation of the image together with the at least one image quality parameter can thus show within the image how the distribution of the image quality is embodied. This can take place independently or combined in any spatial direction of the image. Reliable and meaningful observation and/or assessment of the medical image data captured by way of such a magnetic resonance sequence are thus possible. The proposed method relating to magnetic resonance image data and/or positron emission tomography image data advantageous, as magnetic resonance image data can be captured for a larger area of the body, wherein partial areas of the larger body area can be captured with a longer measuring time, and thus have a higher image quality than other areas of the larger area of the body.

The inventive user interface of at least one embodiment for displaying medical image data has an image data recording unit, an arithmetic unit and a display unit, wherein
the image data recording unit is embodied for the capture of medical image data,
the arithmetic unit is embodied for determining at least one image quality parameter for at least one image of the medical image data, wherein the at least one image quality parameter comprises an image quality of the at least one image based on an item of spatial information and/or an item of temporal information and
the display unit is embodied for the display of the at least one image together with a representation of the at least one image quality parameter.

In particular, the image data recording unit of at least one embodiment is hereby embodied for the loading of the medical image data, in particular from a database. The image data recording unit can also be embodied for the reception of the medical image data from a medical imaging device. Embodiments of the inventive user interface are designed analogously to the embodiments of the inventive method. The user interface can have further control components, which are required and/or advantageous for execution of an inventive method. The user interface can also be embodied to send control signals to a medical imaging device and/or to receive and/or to process control signals, in order to perform an inventive method. Computer programs and further software can be stored in a storage unit of the user interface, by way of which a processor of the user interface automatically controls and/or executes a method sequence of an inventive method. By way of the combined displaying of the medical image data together with the representation of the at least one image quality parameter, the inventive user interface thus enables comprehensible, effective and reliable assessment of the medical image data by an observer.

The inventive medical imaging device of at least one embodiment has an image data recording unit, an arithmetic unit and a display unit, wherein
the image data recording unit is embodied for the capture of medical image data,
the arithmetic unit is embodied for determining at least one image quality parameter for at least one image of the medical image data, wherein the at least one image quality parameter comprises an image quality of the at least one image based on an item of spatial information and/or an item of temporal information and
the display unit is embodied for displaying the at least one image together with a representation of the at least one image quality parameter.

Embodiments of the inventive medical imaging devices are designed analogously to the embodiments of the inventive method. To this end, computer programs and further software, by way of which a processor of the medical imaging device automatically controls and/or executes a method sequence of an inventive method, can be stored in a storage unit of the medical imaging device. By way of the combined display of the medical image data together with the representation of the at least one image quality parameter, the inventive medical imaging device thus enables a comprehensible, effective and reliable assessment of the medical image data by an observer.

One embodiment provides that the medical imaging device has a data transmission unit between the image data recording unit and the arithmetic unit, wherein the data transmission unit is embodied for the transfer of measuring parameters, which are used during capture of the medical image data by way of the medical imaging device, from the image data recording unit to the arithmetic unit, to determine the at least one image quality parameter based on the measuring parameters. The data transmission unit can comprise a data cable and/or an interface. The measuring parameters in particular do not mean those measuring parameters which are not already stored in the arithmetic unit, for example as the result an entry by a user. Rather, those measuring parameters are advantageously meant, which are used in an actual capture of the medical image data by the medical imaging device, for example the actual trajectory of the patient couch and/or the actual spatial distribution of the sensitivity of the medical imaging device. The data transmission unit offers a particularly effective possibility for transfer of the measuring parameters from the image data recording unit to the arithmetic unit, so that the arithmetic unit particularly can calculate the at least one image quality parameter in a simple manner based on the measuring parameters.

The inventive computer program product can be loaded directly into a memory of a programmable arithmetic unit of a user interface, and has program code segments, in order to perform an inventive method, when the computer program product is performed in the arithmetic unit of the user interface. Alternatively or additionally the inventive computer program product can also be able to be loaded directly into a memory of a programmable arithmetic unit of a medical imaging device and have program code segments, in order to perform an inventive method, when the computer program product is performed in the arithmetic unit of the medical imaging device. The inventive method can thereby be performed in a rapid, identically repeatable and robust manner. The computer program product is configured in such a way that it can perform the inventive method step by way of the arithmetic unit. The arithmetic unit must here in each case have the prerequisites, such as for example having an appropriate main memory, an appropriate graphics card or an appropriate logic unit, so that the respective method steps can be performed in an efficient manner. The computer program product is for example stored on a computer-readable medium or on a network or server, from where it can be loaded onto the processor of a local arithmetic unit, which is directly connected to the user interface and/or the medical imaging device or can be embodied as part of the user interface and/or of the medical imaging devices. Furthermore, control information of the computer program product can be stored on an electronically readable data carrier. The control information of the electronically readable data carrier can be embodied in such a way that when the data carrier is used in an arithmetic unit of the user interface and/or of the medical imaging device, it performs an inventive method. Examples of electronically readable data carriers are a DVD, a magnetic tape or a USB stick, on which electronically readable control information, in particular software (cf. above), is stored. When the control information (software) is read from the data carrier and stored in a controller and/or arithmetic unit of the user interface and/or of the medical imaging device, all inventive embodiments of the previously described method can be performed.

The advantages of the inventive user interface, of the inventive medical imaging device and of the inventive computer program product essentially correspond to the advantages of the inventive method, which have previously been listed in detail. Features, advantages or alternative embodiments mentioned here are likewise also to be transferred to the other claimed objects, and vice versa. In other words, the material claims can also be developed with the features which are claimed or described in conjunction with a method. The corresponding functional features of the method are here embodied by way of corresponding material modules, in particular by hardware modules.

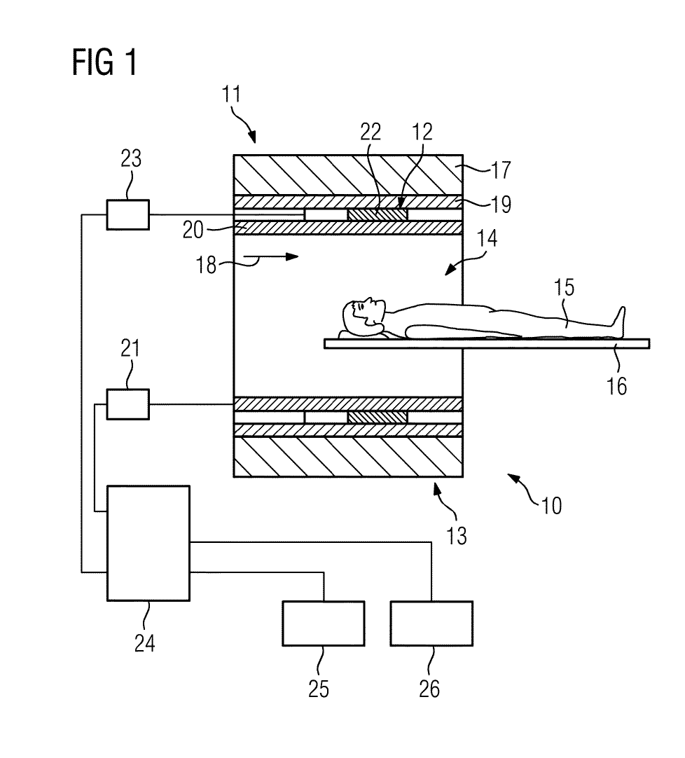

FIG. 1 shows an inventive medical imaging device 10 for performing an inventive method in a schematic representation. The medical imaging device 10 shown is embodied by way of example as a combined medical imaging device 10. In the case shown, the combined medical imaging device 10 has two imaging modalities, a magnetic resonance device 11 and a PET device 12. The magnetic resonance device 11 and the PET device 12 here serve as image data recording units. The combined medical imaging device 10 is thus a combined magnetic resonance positron emission tomography device 10 (magnetic resonance PET device).

Alternatively, the medical imaging device 10 can also be a magnetic resonance device, a single photon emission tomography device (SPECT device), a positron emission tomography device (PET device), a computer tomograph, an ultrasound device, an X-ray device or a C-arm device. Combined medical imaging devices 10 are also possible here, which comprise any desired combination of a multiplicity of the imaging modalities cited. In FIG. 1 to FIG. 3 the inventive method is represented based on a concrete magnetic resonance PET device 10 solely by way of illustration.

The magnetic resonance device 11 comprises a magnet unit 13 and a patient receiving area 14 surrounded by the magnet unit 13 for capture of an object under investigation 15, in particular of a patient 15, wherein the patient receiving area 14 is surrounded in a peripheral direction by the magnet unit 13 in cylindrical form. The patient 15 can be conveyed into the patient receiving area 14 by way of a patient support apparatus 16 of the magnetic resonance device 11. To this end, the patient support apparatus 16 is arranged in a movable manner within the patient receiving area 16.

The magnet unit 13 comprises a main magnet 17, which for operation of the magnetic resonance device 11 is designed for the generation of a strong and in particular constant main magnetic field 18. The magnet unit 13 further has a gradient coil unit 19 for generation of magnetic field gradients, which is used for spatial coding during imaging. The gradient coil unit 19 is further embodied for the generation of gradient fields. In addition the magnet unit 13 comprises a body coil 20, which is provided to excite a polarization which arises in the main magnetic field 18 generated by the main magnet 17. The body coil 20 is further provided to receive magnetic resonance signals. The body coil 20 is embodied for reception of a first and second signal frequency. The body coil 20 is permanently integrated within the magnet unit.

For control of the main magnet of the gradient coil unit 19 and for control of the body coil 20 the magnetic resonance PET device 10, in particular the magnetic resonance device 11, has a magnetic resonance control unit 21. The magnetic resonance control unit 21 controls the magnetic resonance device 11 centrally, such as for example the performing of a predetermined imaging gradient echo sequence. To this end the magnetic resonance control unit 21 comprises a gradient control unit which is not shown in greater detail and a high-frequency antenna control unit, which is not shown in greater detail. In addition the magnetic resonance control unit 21 comprises an evaluation unit for evaluation of magnetic resonance image data or magnetic resonance signals.

The magnetic resonance device 11 shown can of course comprise further components, which magnetic resonance devices 11 usually possess. A general mode of functioning of a magnetic resonance device 11 is additionally familiar to the person skilled in the art, so that a detailed description of the general components can be dispensed with.

The PET device 12 comprises a multiplicity of positron emission tomography detector modules 22 (PET detector modules 22), which are arranged in annular form, and surround the patient receiving area 14 in the peripheral direction. The PET detector modules 22 in each case have a multiplicity of positron emission tomography detector elements (PET detector elements), not shown in greater detail, which are arranged into a PET detector array, which comprises a scintillation detector array with scintillation crystals, for example LSO crystals. The PET detector modules 22 further comprise in each case a photodiode array, for example an avalanche photodiode array or APD photodiode array, which are arranged downstream of the scintillation detector array within the PET detector module 22.

Pairs of photons which result from the annihilation of a positron with an electron are recorded by way of PET detector modules 22. Trajectories of the two photons enclose an angle of 180°. In addition, the two photons have an energy of 511 keV. The positron is here emitted by a radiopharmacon, wherein the radiopharmacon is enriched via an injection to the patient 15. The photons occurring in the annihilation can be attenuated upon passing through material, wherein the likelihood of attenuation depends on the length of the path through the material and the corresponding attenuation coefficients of the material. Accordingly, when evaluating the PET signals a correction of these signals related to attenuation by components located in the beam path, is necessary.

In addition the PET detector modules 22 in each case have a detector electronics unit, which comprises an electrical amplifier circuit and further electronic components, not shown in further detail. The magnetic resonance PET device 10, in particular the PET device 12, has a PET control unit 23 for control of the detector electronics unit and the PET detector modules 22. The PET control unit 23 controls the PET device 12 centrally. In addition the PET control unit 23 comprises an evaluation unit for the evaluation of PET data.

The PET device 12 shown can of course comprise further components, which PET devices 12 usually possess. A general mode of functioning of a PET device 12 is additionally familiar to the person skilled in the art, so that a detailed description of the general components can be dispensed with.

The magnetic resonance PET device 10 additionally has a central arithmetic unit 24, which for example harmonizes capture and/or evaluation of magnetic resonance image data and of PET image data. The arithmetic unit 24 can be a central system control unit. Control information such as for example imaging parameters, as well as reconstructed image data, can be displayed on a display unit 25, for example on at least one monitor, of the magnetic resonance PET device 10 for an operator. In addition the magnetic resonance PET device 10 has an input unit 26, by which information and/or measuring parameters during a measuring procedure can be entered by an operator. The display unit 25 and the arithmetic unit 24 can comprise a user interface, which is not shown. The user interface can then further comprise the input unit 26 and/or an image data recording unit, in particular for the loading of medical image data from a database. The user interface is then embodied to perform an inventive method.

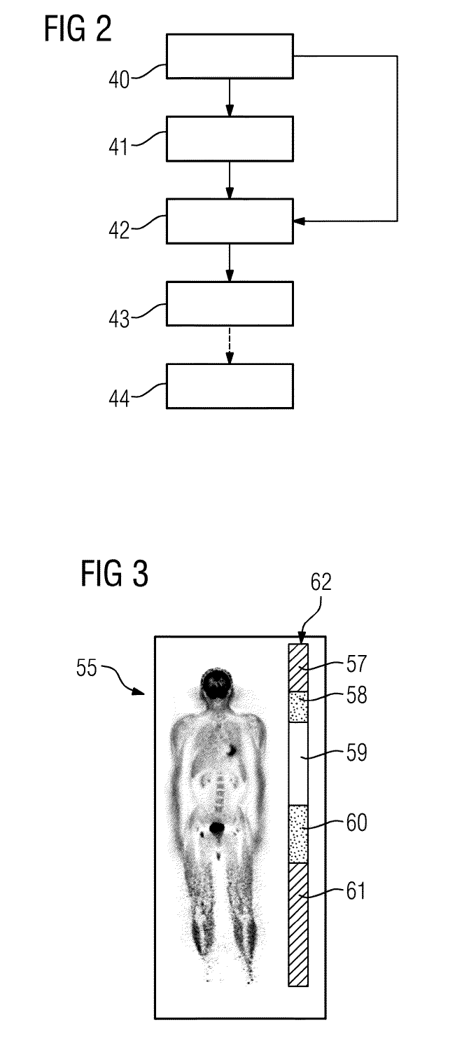

FIG. 2 shows a flow chart for an embodiment of an inventive method. In a first method step 40 capture of a PET raw image data record of the patient 15 takes place by way of the PET device 12 and capture of a magnetic resonance raw image data record of the patient 15 by way of the magnetic resonance device 11. The capture of the PET raw image data record and of the magnetic resonance raw image data record here comprises a continuous movement of the patient support apparatus 16 and thus of the patient 15. Alternatively, the capture of raw image data records with a multiplicity of positions, in particular recording positions, of the patient support apparatus 16, so-called bed positions, is also possible. The capture of the magnetic resonance raw image data record takes place using a magnetic resonance sequence, wherein the magnetic resonance sequence comprises a parallel imaging component.

In a further method step 41 PET image data is generated from the PET raw image data record by way of the PET control unit 23 and the arithmetic unit 24, and magnetic resonance image data generated from the magnetic resonance raw image data record by way of the magnetic resonance control unit 21 and the arithmetic unit 24. The PET image data and the magnetic resonance image data here comprise for example in each case a multiplicity of slices (images) in the axial direction along the direction of the main magnetic field 18. The first method step 40 and/or the further method step 41 here represent a possibility for capture of the PET image data and the magnetic resonance image data. Other procedures for capture of the PET image data and the magnetic resonance image data are of course conceivable.

In a further method step 42 a PET image quality parameter is in each case determined for each slice of the PET image data by way of the arithmetic unit 24, based on the PET image data. Further, a magnetic resonance image quality parameter is in each case determined for each slice of the magnetic resonance image data by way of the arithmetic unit 24, based on the magnetic resonance image. The determining of the image quality parameters can also take place for individual voxels, lines and/or columns at least one image of the image data records. The PET image quality parameter is here the slice-by-slice averaged signal-to-noise ratio of the PET image data divided by a reference value, which is for example the maximum signal-to-noise ratio of a slice of the PET image data measured in the PET image data. The magnetic resonance image quality parameter is the slice-by-slice averaged contrast-to-noise ratio of the magnetic resonance image data. The magnetic resonance image quality parameters too can be calculated depending on a suitable reference value. The PET image quality parameter and the magnetic resonance image quality parameter thus comprise, in particular describe, an image quality in each case of a slice of the PET image data or the magnetic resonance image data based on an item of spatial information, the position of the slice in the axial direction.

As an alternative to the determining of the PET image quality parameter by way of the PET image data, determining of the PET image quality parameter can also take place based on PET measuring parameters, which are used during capture of the PET raw image data record. To this end, the medical imaging device 10 has a data transmission unit (not shown), for example an interface (the PET control unit 23) and/or a data cable, between the PET device 12 and the arithmetic unit 24, wherein the data transmission unit is embodied for transfer of the measuring parameters, which are used during capture of the PET raw image data record by way of the PET device 12, from the PET device 12 to the arithmetic unit 24. Determining of the PET image quality parameter can here take place based on a trajectory of the patient support apparatus 16 during the capture of the PET raw image data record. The dwell time of the patient support apparatus 16 in a particular position can here be taken into account. The determining of the PET image quality parameter can take place subject to an additional weighting of the spatial sensitivity of the PET detector modules 22 and a decay curve of the activity of the radiopharmacon. A weighting with the respectively local attenuation and/or dispersion of the photon pairs can also be carried out.

In a further method step 43 display of the slices of the PET image data and the magnetic resonance image data by way of the display unit 25 takes place, together with in each case a representation of the PET image quality parameter and of the magnetic resonance image quality parameter.

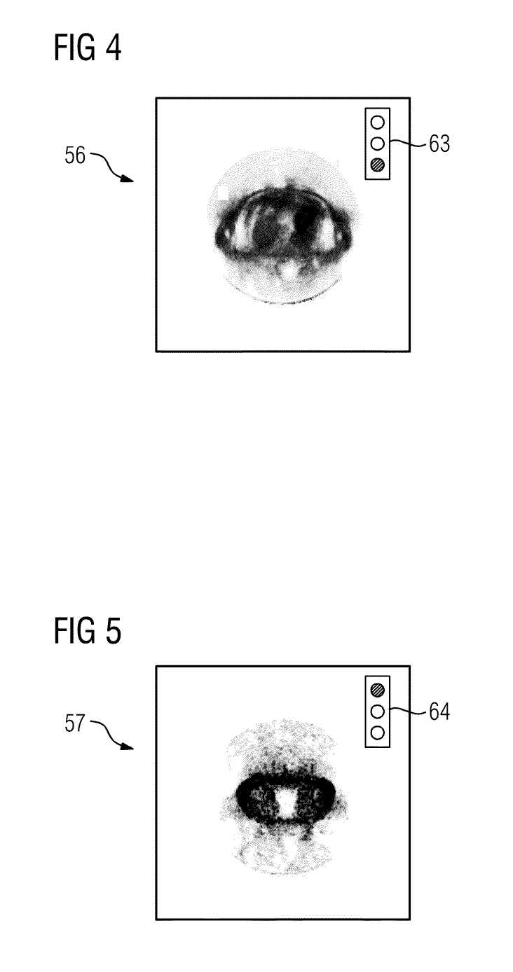

FIG. 3-5 here in each case show part of a user interface of the display unit 25, on which in each case an image 55,56,57 of the PET image data with in each case a representation of the associated PET image quality parameter are represented. The first image 55 in FIG. 3 shows a coronal view of the patient 15. The second image 56 in FIG. 4 shows an axial view of the patient 15 at the level of the thorax of the patient 15. The third image 57 in FIG. 5 shows an axial view of the patient 15 at the level of the leg area of the patient 15. The first image 55 is represented together with a bar diagram 62 of the change of the PET image quality parameter along the longitudinal direction of the patient 15, the axial spatial direction (z direction), on the display unit 25. The second and third image 56,57 in each case show a traffic signal 63,64, which indicates what value the PET image quality parameter for the slice of the PET image data shown in the respective image 56,57 has, in relation to two threshold values.

The representation of the PET image quality parameter on the display unit 25 comprises a color coding of the PET image quality parameter, wherein the color coding depends on a value of the image quality parameter. The color coding in particular depends on, in particular adjustable, threshold values for the value of the PET image quality parameter. By way of example, the PET image quality parameter is specified as a percentage value depending on the reference value. An example setting of threshold values with two threshold values is shown. A PET image quality parameter with a value of less than 50 percent of the reference value is shown in red. A PET image quality parameter with a value between 50 and 95 percent of the reference value is shown in yellow and a PET image quality parameter with a value of greater than 95 percent of the reference value is shown in green. Other color codings, also including grayscales, and a divergent number of threshold values and divergent values as threshold values are of course also possible.

In the present case, in the first method step 40 a slow speed of the patient support apparatus 16 in the case of continuous movement of the patient support apparatus 16 was selected during capture of the PET raw image data record in the thorax area and abdominal area of the patient 15. In the head area and leg area of the patient 15 a faster speed of the patient support apparatus 16 was selected in the case of continuous movement of the patient support apparatus 16. The relative noise of the PET image data in the head area and leg area thus increases sharply, so that in the head section 57 and leg section 61 of the bar diagram 62 of the PET image quality parameter, a PET image quality parameter of less than 50 percent and thus a red color (shown in cross-hatched form) is present. In the thorax-abdomen section 59 of the bar diagram 62, because of the slow speed of the patient support apparatus 16, a PET image quality parameter of greater than 95 percent and thus a green color (shown as white) applies. In two intermediate areas 58,60 of the bar diagram 62 of the PET image quality parameter a PET image quality parameter between 50 and 95 percent and thus a yellow color (shown in dotted form) is present. In reference to the second image 56, the lower green light of the traffic signal 63 is illuminated, as the second image 56 is arranged in the thorax area of the patient 15. With reference to the third image 57, however, the upper red light of the traffic signal 64 lights up, as the third image 57 is arranged in the leg area of the patient 15. Other representations of the PET image quality parameter than those shown in FIG. 3-5 are of course possible. An overlaying of a PET image quality parameter map over the PET image data, which is not shown, is also possible. Combined display of the magnetic resonance image data together with a representation of the magnetic resonance image quality parameter is not shown. It is however sensible, as the magnetic resonance image data can have inhomogeneous image quality as a result of the capture by way of a magnetic resonance sequence with a parallel imaging component.

in a further method step 44 (see FIG. 2) planning of a remeasurement by way of the PET device 12 for the capture of further PET image data, on the basis of the spatially resolved distribution of the PET image quality parameter, can finally take place at the wish of a user. The planning of the remeasurement provided to the user can be adapted by the user, depending on the PET image data displayed and the representation of the PET image quality parameter displayed, and finally performed by way of the PET device 12. For certain regions of the body, in the case shown for the head area and leg area of the patient 15, additional PET image data can then be captured, and thus the signal statistics improved, so that the image quality of the PET image data is homogenized. The additional PET image data then has a distribution of the PET image quality parameters of such a kind that the PET image quality parameter for each slice has a minimum value, for example of 50 percent, and is thus shown in yellow.

The method steps of the inventive method illustrated in FIG. 2 and in FIG. 3-5 are performed by the magnetic resonance PET device 10, in particular the user interface of the magnetic resonance PET device 10. To this end the arithmetic unit 24 of the magnetic resonance PET device 10, in particular the arithmetic unit 24 of the user interface of the magnetic resonance PET device 10, comprises requisite software and/or computer programs, which are stored in a storage unit of the arithmetic unit 24. The software and/or computer programs comprise program segments, which are designed to execute the inventive method when the computer program and/or the software in the arithmetic unit 24 is performed by way of a processor unit of the magnetic resonance PET device 10, in particular a processor unit of the user interface of the magnetic resonance PET device 10.

Although the invention has been illustrated and described in detail by way of the preferred example embodiments, the invention is nevertheless not limited by the examples disclosed, and other variations can be derived therefrom by the person skilled in the art, without departing from the scope of the invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for displaying medical image data, comprising:
capturing of medical image data;
determining at least one image quality parameter for at least one image of the medical image data, wherein the at least one image quality parameter comprises an image quality of the at least one image based on at least one of an item of spatial information and an item of temporal information; and
displaying the at least one image together with a representation of the at least one image quality parameter.

2. The method of claim 1, wherein the at least one image quality parameter describes a relationship between at least one of a signal strength and a contrast strength of the medical image data and a noise of the medical image data.

3. The method of claim 1, wherein the representation of the at least one image quality parameter comprises a color coding of the at least one image quality parameter, wherein the color coding depends on at least one value of the at least one image quality parameter.

4. The method of claim 3, wherein the color coding is dependent on at least one threshold value for the at least one value of the at least one image quality parameter.

5. The method of claim 1, wherein the representation of the at least one image quality parameter comprises a representation of a change of the at least one image quality parameter along at least one of at least one spatial and temporal dimension of the at least one image.

6. The method of claim 1, wherein the determining of the at least one image quality parameter takes place depending on a reference value of the at least one image quality parameter.

7. The method of claim 1, wherein the at least one image quality parameter is determined by way of the medical image data.

8. The method of claim 1, wherein the at least one image quality parameter is determined based on measuring parameters, which are set for capture of the medical image data.

9. The method of claim 1, wherein a re-measurement for the capture of further medical image data by way of a medical imaging devices is planned, on the basis of a spatially resolved distribution of the at least one image quality parameter, wherein the at least one image quality parameter of the further medical image data has a minimum value.

10. The method of claim 9, wherein an adjustment of remeasurement parameters for the remeasurement takes place depending on the at least one image quality parameter.

11. The method of claim 1, wherein the provision of the medical image data comprises capture of a raw image data record, wherein the medical image data is generated on the basis of the raw image data record.

12. The method of claim 11, wherein the recording of the raw image data record takes place in different recording positions.

13. The method of claim 11, wherein the recording of the raw image data record takes place by way of a medical imaging device with a patient couch and a patient arranged on the patient couch, wherein the recording of the raw image data record takes place subject to a continuous movement of the patient couch.

14. The method of claim 11, wherein the recording of the raw image data record by way of a magnetic resonance device takes place using a magnetic resonance sequence, wherein the magnetic resonance sequence comprises a parallel imaging component.

15. A user interface for displaying medical image data with an image data recording unit, an arithmetic unit and a display unit, wherein
the image data recording unit is embodied to capture the medical image data,
the arithmetic unit is embodied to determine at least one image quality parameter for at least one image of the medical image data, wherein the at least one image quality parameter comprises an image quality of the at least one image based on at least one of an item of spatial information and an item of temporal information and
the display unit is embodied to display the at least one image together with a representation of the at least one image quality parameter.

16. A medical imaging device comprising:
an image data recording unit;
an arithmetic unit; and
a display unit, wherein
the image data recording unit is embodied to capture medical image data,
the arithmetic unit is embodied to determine at least one image quality parameter for at least one image of the medical image data, wherein the at least one image quality parameter comprises an image quality of the at least one image based on at least one of an item of spatial information and an item of temporal information, and
the display unit is embodied to display the at least one image together with a representation of the at least one image quality parameter.

17. The medical imaging device of claim 16, further comprising:
a data transmission unit between the image data recording unit and the arithmetic unit, wherein the data transmission unit is embodied to transfer measuring parameters, used during capture of the medical image data by way of the medical imaging device, from the image data recording unit to the arithmetic unit for determining the at least one image quality parameter based on the measuring parameters.

18. A computer program product, directly loadable into a memory of a programmable control device of a user interface, including program code segments to perform the method of claim 1 when the computer program product is executed in the control device of the medical imaging device.

19. The method of claim 12, wherein the recording of the raw image data record takes place by way of a medical imaging device with a patient couch and a patient arranged on the patient couch, wherein the recording of the raw image data record takes place subject to a continuous movement of the patient couch.

20. The method of claim 2, wherein the representation of the at least one image quality parameter comprises a color coding of the at least one image quality parameter, wherein the color coding depends on at least one value of the at least one image quality parameter.

21. The method of claim 21, wherein the color coding is dependent on at least one threshold value for the at least one value of the at least one image quality parameter.
